(19) United States
(12) Patent Application Publication
(10) Pub. No.: US 2025/0004771 A1
(43) Pub. Date: Jan. 2, 2025

(54) GENERATING INSTRUCTION DATA

(71) Applicant: BEIJING BAIDU NETCOM SCIENCE TECHNOLOGY CO., LTD., BEIJING (CN)

(72) Inventors: Haifeng WANG, BEIJING (CN); Hua WU, BEIJING (CN); Dai DAI, BEIJING (CN); Jing LIU, BEIJING (CN); Hongyu LI, BEIJING (CN); Gangqiang HU, BEIJING (CN)

(73) Assignee: BEIJING BAIDU NETCOM SCIENCE TECHNOLOGY CO., LTD., BEIJING (CN)

(21) Appl. No.: 18/755,148

(22) Filed: Jun. 26, 2024

(30) Foreign Application Priority Data
Jun. 30, 2023 (CN) 202310804563.5

(51) Int. Cl. G06F 9/30; G06F 40/20

(52) U.S. Cl. CPC G06F 9/30145; G06F 40/20

(57) ABSTRACT

A method, apparatus, device, and medium for generating instruction data is provided. The method includes: obtaining a natural language-based reference instruction to direct a large model to generate response data meeting multiple first requirements; obtaining a structured disassembly result of the reference instruction to derive several reference slots and slot values corresponding to these requirements; determining multiple sample slots and sample slot values based on the reference slots, slot values, and a predetermined rule; and generating a natural language-based sample instruction from these sample slots and values, which directs the large model to generate response data that fulfills multiple second requirements.

### CROSS REFERENCE TO RELATED APPLICATION

This application claims priority to Chinese Patent Application No. 202310804563.5, filed on Jun. 30, 2023, the contents of which are hereby incorporated by reference in their entirety for all purposes.

### TECHNICAL FIELD

The present disclosure relates to the technical field of artificial intelligence, particularly to the technical field of natural language processing and the like, and specifically to a method of generating instruction data for a large model, an apparatus of generating instruction data for a large model, an electronic device, a computer-readable storage medium, and a computer program product.

### BACKGROUND

Artificial intelligence is the discipline of studying of making computers simulate certain thinking processes and intelligent behaviors of a human being (such as learning, reasoning, thinking, planning, etc.), and there are both hardware-level and software-level technologies. The artificial intelligence hardware technologies generally include technologies such as sensors, special artificial intelligence chips, cloud computing, distributed storage, large data processing, etc.; The artificial intelligence software technologies mainly include natural language processing technology, computer vision technology, speech recognition technology, machine learning/deep learning, large data processing technology, knowledge graph technology and other major technological directions.

The methods described in this section are not necessarily methods that have been previously conceived or employed. Unless otherwise indicated, it should not be assumed that any method described in this section is considered to be the prior art only due to its inclusion in this section. Similarly, the problems mentioned in this section should not be assumed to be recognized in any prior art unless otherwise indicated.

### SUMMARY

The present disclosure provides a method of generating instruction data for a large model, an apparatus of generating instruction data for a large model, an electronic device, a computer-readable storage medium, and a computer program product.

According to an aspect of the present disclosure, there is provided a computer-implemented method of generating instruction data for a large model, including: obtaining a natural language-based reference instruction which can instruct the large model to generate response data that satisfies a plurality of first requirements corresponding to a plurality of first requirement categories; obtaining a structured disassembly result of the reference instruction to obtain a plurality of reference slots corresponding to the plurality of first requirement categories and a plurality of reference slot values corresponding to the plurality of first requirements; determining a plurality of sample slots and a plurality of sample slot values corresponding to the plurality of sample slots based on the plurality of reference slots, the plurality of reference slot values, and a predetermined rule; and generating a natural language-based sample instruction based on the plurality of sample slots and the plurality of sample slot values, and the sample instruction can instruct the large model to generate response data that satisfies a plurality of second requirements corresponding to the plurality of sample slot values.

According to another aspect of the present disclosure, there is provided an apparatus of generating instruction data for a large model, including: a first obtaining unit configured to obtain a natural language-based reference instruction which can instruct the large model to generate response data that can satisfy a plurality of first requirements corresponding to a plurality of first requirement categories; a second obtaining unit configured to obtain a structured disassembly result of the reference instruction to obtain a plurality of reference slots corresponding to the plurality of first requirement categories and a plurality of reference slot values corresponding to the plurality of first requirements; a determination unit configured to determine a plurality of sample slots and a plurality of sample slot values corresponding to the plurality of sample slots based on the plurality of reference slots, the plurality of reference slot values, and a predetermined rule; and a generation unit configured to generate a natural language-based sample instruction based on the plurality of sample slots and the plurality of sample slot values, and the sample instruction can instruct the large model to generate response data that satisfies a plurality of second requirements corresponding to the plurality of sample slot values.

According to another aspect of the present disclosure, there is provided an electronic device, one or more processors; a memory storing one or more programs configured to be executed by the one or more processors, the one or more programs including instructions for: obtaining a natural language-based reference instruction, where the reference instruction can instruct the large model to generate response data that satisfies a plurality of first requirements corresponding to a plurality of first requirement categories; obtaining a structured disassembly result of the reference instruction to obtain a plurality of reference slots corresponding to the plurality of first requirement categories and a plurality of reference slot values corresponding to the plurality of first requirements; determining a plurality of sample slots and a plurality of sample slot values corresponding to the plurality of sample slots based on the plurality of reference slots, the plurality of reference slot values, and a predetermined rule; and generating a natural language-based sample instruction based on the plurality of sample slots and the plurality of sample slot values, where the sample instruction can instruct the large model to generate response data that satisfies a plurality of second requirements corresponding to the plurality of sample slot values.

According to another aspect of the present disclosure, there is provided a non-transient computer-readable storage medium storing one or more programs, the one or more programs including instructions, which when executed by one or more processors of an electronic device, cause the electronic device to: obtain a natural language-based reference instruction, where the reference instruction can instruct the large model to generate response data that satisfies a plurality of first requirements corresponding to a plurality of first requirement categories; obtain a structured disassembly result of the reference instruction to obtain a plurality of reference slots corresponding to the plurality of first requirement categories and a plurality of reference slot values corresponding to the plurality of first requirements; determine a plurality of sample slots and a plurality of sample slot values corresponding to the plurality of sample slots based on the plurality of reference slots, the plurality of reference slot values, and a predetermined rule; and generate a natural language-based sample instruction based on the plurality of sample slots and the plurality of sample slot values, where the sample instruction can instruct the large model to generate response data that satisfies a plurality of second requirements corresponding to the plurality of sample slot values.

According to another aspect of the present disclosure, there is provided a computer program product, including a computer program, where the computer program implements the method described above when executed by a processor.

According to one or more embodiments of the present disclosure, the present disclosure obtains the plurality of reference slots corresponding to requirement categories and the plurality of reference slot values corresponding to the specific requirement of each requirement category by structurally disassembling the natural language-based reference instruction, and then determines the plurality of sample slots and the plurality of sample slot values for generating the sample instruction based on the plurality of reference slots, the plurality of reference slot values and the predetermined rule, and finally obtains the natural language-based sample instruction, thereby enhancing the flexibility of the instruction training data generation process, providing more complex, diverse, targeted and directed instruction training data to the generative large model, and effectively enhancing the instruction compliance capability of the large model.

It should be understood that the content described in this section is not intended to identify key or important features of the embodiments of the present disclosure, nor is it intended to limit the scope of the present disclosure. Other features of the present disclosure will become readily understood from the following specification.

### BRIEF DESCRIPTION OF THE DRAWINGS

The drawings exemplarily illustrate embodiments and constitute a part of the specification and are used in conjunction with the textual description of the specification to explain the example implementations of the embodiments. The illustrated embodiments are for illustrative purposes only and do not limit the scope of the claims. Throughout the drawings, like reference numerals refer to similar but not necessarily identical elements.

FIG. 1 illustrates a schematic diagram of an example system in which various methods described herein may be implemented according to embodiments of the present disclosure;

FIG. 2 illustrates a flowchart of a method of generating instruction data for a large model according to embodiments of the present disclosure;

FIG. 3 illustrates a flowchart of determining a plurality of sample slots and a plurality of sample slot values corresponding to the plurality of sample slots according to embodiments of the present disclosure;

FIG. 4 illustrates a flowchart of a method of generating instruction data for a large model according to embodiments of the present disclosure;

FIG. 5 illustrates a structural block diagram of an apparatus of generating instruction data for a large model according to embodiments of the present disclosure; and

FIG. 6 illustrates a structural block diagram of an example electronic device that can be used to implement embodiments of the present disclosure.

### IMPLEMENTATIONS

The example embodiments of the present disclosure are described below in conjunction with the accompanying drawings, which include various details of the embodiments of the present disclosure to facilitate understanding and should be considered as examples only. Therefore, one of ordinary skill in the art will recognize that various changes and modifications may be made to the embodiments described herein without departing from the scope of the present disclosure. Similarly, descriptions of well-known functions and structures are omitted in the following description for the purpose of clarity and conciseness.

In the present disclosure, unless otherwise specified, the terms “first”, “second” and the like are used to describe various elements and are not intended to limit the positional relationship, timing relationship, or importance relationship of these elements, and such terms are only used to distinguish one element from another. In some examples, a first element and a second element may refer to the same instance of the element, while in some cases they may also refer to different instances based on the description of the context.

The terminology used in the description for the various examples in this disclosure is for the purpose of describing specific examples only and is not intended to be limiting. Unless the context clearly indicates otherwise, if the number of elements is not specifically defined, the element may be one or more. In addition, the terms “and/or” used in the present disclosure encompass any one of the listed items and all the possible combinations thereof.

Generally, in the related art, only manually written instruction data is relied on to train the instruction compliance capability of the large model, and such data may lack pertinence and directivity.

To address the problem described above, the present disclosure obtains a plurality of reference slots corresponding to requirement categories and a plurality of reference slot values corresponding to the specific requirement of each requirement category by structurally disassembling a natural language-based reference instruction, and then determines a plurality of sample slots and a plurality of sample slot values for generating a sample instruction based on the plurality of reference slots, the plurality of reference slot values and a predetermined rule, and finally obtains a natural language-based sample instruction, thereby enhancing the flexibility of the instruction training data generation process, providing more complex, diverse, targeted and directed instruction training data to the generative large model, and effectively enhancing the instruction compliance capability of the large model.

Embodiments of the present disclosure will be described in detail below with reference to the accompanying drawings.

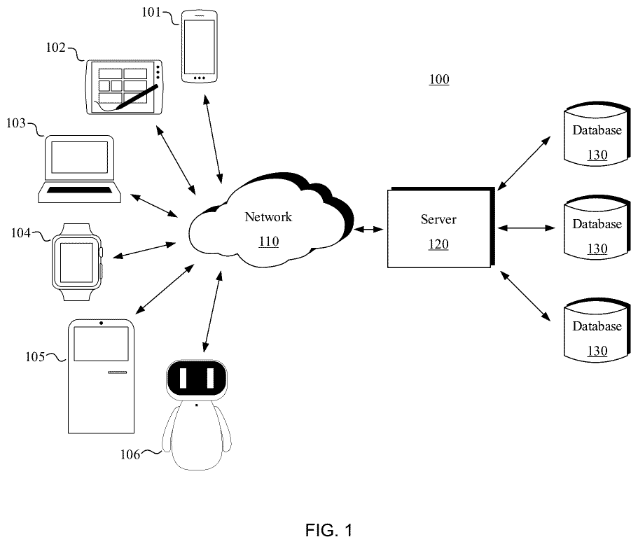

FIG. 1 illustrates a schematic diagram of an example system 100 in which various methods and apparatuses described herein may be implemented in accordance with embodiments of the present disclosure. Referring to FIG. 1, the system 100 includes one or more client devices 101, 102, 103, 104, 105, and 106, a server 120, and one or more communication networks 110 that couple the one or more client devices to the server 120. The client devices 101, 102, 103, 104, 105, and 106 may be configured to execute one or more applications.

In embodiments of the present disclosure, the server 120 may run one or more services or software applications that enable the execution of a method of generating instruction data for a large model. In an example embodiment, a large model may be deployed on the server.

In some embodiments, the server 120 may further provide other services or software applications, which may include non-virtual environments and virtual environments. In some embodiments, these services may be provided as web-based services or cloud services, such as to users of the client devices 101, 102, 103, 104, 105, and/or 106 under a Software as a Service (SaaS) model.

In the configuration shown in FIG. 1, the server 120 may include one or more components that implement functions performed by the server 120. These components may include software components, hardware components, or combinations thereof that are executable by one or more processors. A user operating the client devices 101, 102, 103, 104, 105, and/or 106 may sequentially utilize one or more client applications to interact with the server 120 to utilize the services provided by these components. It should be understood that a variety of different system configurations are possible, which may be different from the system 100. Therefore, FIG. 1 is an example of a system for implementing the various methods described herein and is not intended to be limiting.

The user may use the client devices 101, 102, 103, 104, 105, and/or 106 to generate response data using a large model. The client devices may provide interfaces that enable the user of the client devices to interact with the client devices. The client devices may also output information to the user via the interfaces, for example, may output to the user the response of the large model to user's input. Although FIG. 1 depicts only six client devices, those skilled in the art will understand that the present disclosure may support any number of client devices.

The client devices 101, 102, 103, 104, 105, and/or 106 may include various types of computer devices, for example, portable handheld devices, general-purpose computers (such as personal computers and laptop computers), workstation computers, wearable devices, smart screen devices, self-service terminal devices, service robots, gaming systems, thin clients, various messaging devices, sensors or other sensing devices, and the like. These computer devices may run various types and versions of software applications and operating systems, such as Microsoft Windows, Apple IOS, Unix-like operating systems, Linux or Linux-like operating systems (e.g., Google Chrome OS); or include various mobile operating systems, such as Microsoft Windows Mobile OS, iOS, Windows Phone, Android. The portable handheld devices may include cellular phones, smart phones, tablet computers, personal digital assistants (PDA), and the like. The wearable devices may include head-mounted displays (such as smart glasses) and other devices. The gaming systems may include various handheld gaming devices, Internet-enabled gaming devices, and the like. The client devices can execute various different applications, such as various Internet related applications, communication applications (e.g., e-mail applications), Short Message Service (SMS) applications, and may use various communication protocols.

The network 110 may be any type of network well known to those skilled in the art, which may support data communication using any of a variety of available protocols (including but not limited to TCP/IP, SNA, IPX, etc.). By way of example only, one or more networks 110 may be a local area network (LAN), an Ethernet-based network, a token ring, a wide area network (WAN), an Internet, a virtual network, a virtual private network (VPN), an intranet, an external network, a blockchain network, a public switched telephone network (PSTN), an infrared network, a wireless network (e.g., Bluetooth, WiFi), and/or any combination of these and/or other networks.

The server 120 may include one or more general-purpose computers, a dedicated server computer (e.g., a PC (personal computer) server, a UNIX server, a mid-end server), a blade server, a mainframe computer, a server cluster, or any other suitable arrangement and/or combination. The server 120 may include one or more virtual machines running a virtual operating system, or other computing architectures involving virtualization (e.g., one or more flexible pools of a logical storage device that may be virtualized to maintain virtual storage devices of a server). In various embodiments, the server 120 may run one or more services or software applications that provide the functions described below.

The computing unit in the server 120 may run one or more operating systems including any of the operating systems described above and any commercially available server operating system. The server 120 may also run any of a variety of additional server applications and/or intermediate layer applications, including a HTTP server, an FTP server, a CGI server, a Java server, a database server, etc.

In some implementations, the server 120 may include one or more applications to analyze and merge data feeds and/or event updates received from the user of the client devices 101, 102, 103, 104, 105, and/or 106. The server 120 may also include one or more applications to display the data feeds and/or the real-time events via one or more display devices of the client devices 101, 102, 103, 104, 105, and/or 106.

In some embodiments, the server 120 may be a server of a distributed system, or a server incorporating a blockchain. The server 120 may also be a cloud server, or an intelligent cloud computing server or an intelligent cloud host with an artificial intelligence technology. The cloud server is a host product in the cloud computing service system used to overcome the defects of high management difficulty and weak service expansibility which exist in the conventional physical host and Virtual Private Server (VPS) service.

The system 100 may also include one or more databases 130. In certain embodiments, these databases may be used to store data and other information. For example, one or more of the databases 130 may be used to store information such as audio files and video files. The databases 130 may reside in various locations. For example, the database used by the server 120 may be local to the server 120, or may be remote from the server 120 and may communicate with the server 120 via a network-based or dedicated connection. The database 130 may be of a different type. In some embodiments, the database used by the server 120 may be, for example, a relational database. One or more of these databases may store, update, and retrieve data to and from the database in response to a command.

In some embodiments, one or more of the databases 130 may also be used by an application to store application data. The database used by the application may be a different type of database, such as a key-value repository, an object repository, or a conventional repository supported by a file system.

The system 100 of FIG. 1 may be configured and operated in various ways to enable application of various methods and devices described according to the present disclosure.

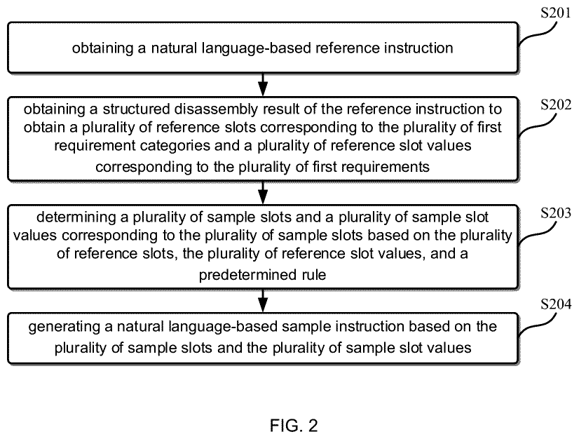

According to an aspect of the present disclosure, there is provided a computer-implemented method of generating instruction data for a large model. As shown in FIG. 2, the method of generating instruction data for the large model includes: step S201, obtaining a natural language-based reference instruction which can instruct the large model to generate response data that satisfies a plurality of first requirements corresponding to a plurality of first requirement categories; step S202, obtaining a structured disassembly result of the reference instruction to obtain a plurality of reference slots corresponding to the plurality of first requirement categories and a plurality of reference slot values corresponding to the plurality of first requirements; step S203, determining a plurality of sample slots and a plurality of sample slot values corresponding to the plurality of sample slots based on the plurality of reference slots, the plurality of reference slot values, and a predetermined rule; and step S204, generating a natural language-based sample instruction based on the plurality of sample slots and the plurality of sample slot values, and the sample instruction can instruct the large model to generate response data that satisfies a plurality of second requirements corresponding to the plurality of sample slot values.

Thereby, the plurality of reference slots corresponding to requirement categories and the plurality of reference slot values corresponding to the specific requirement of each requirement category can be obtained by structurally disassembling the natural language-based reference instruction, and thus the plurality of sample slots and the plurality of sample slot values for generating the sample instruction can be determined based on the plurality of reference slots, the plurality of reference slot values and the predetermined rule, and finally the natural language-based sample instruction can be obtained, thereby enhancing the flexibility of the instruction training data generation process, providing more complex, diverse, targeted and directed instruction training data to the generative large model, and effectively enhancing the instruction compliance capability of the large model.

In the present disclosure, the large model is a deep learning-based generative large model. The large model has an end-to-end characteristic that enables direct generation of response data based on instruction data input by a user. In other words, the large model itself has a generation function. In some embodiments, the large model may be a deep learning-based large language model. A large language model usually has billions or even hundreds of billions of parameters and is usually trained on large-scale textual data or data in other modalities. The large language models can be used for a variety of natural language processing tasks, such as text generation, language translation, and question and answer systems, etc.

The large model may, for example, be an N-layer Transformer network architecture with an Encoder and a Decoder, or be a Unified pre-trained Language Model (UniLM) network architecture. It can be understood that the Large Model may also be another neural network model based on the Transformer network architecture, which is not limited herein. Both the input and the output of the large model are composed of tokens. Each token may correspond to a single word, character, word, or special symbol. The large model may be trained using a pre-training task and fine-tuned using instruction data and the corresponding ground truth response data to have the generation function described above.

In some embodiments, in step S201, training instructions may be obtained from a training set and real target instructions may be obtained from online user logs, and these instructions may be used as reference instructions. In an example embodiment, the example reference instruction may be “Please write an essay of less than 100 words about wine, and the word ‘wine’ cannot appear in the whole text”. This reference instruction involves five first requirement categories, namely, “tasks to be performed by the large model”, “genre of the generated content”, “topic of the generated content”, “word count of the generated content”, and “requirements of the generated content”, and for the five first requirement categories, there are five first requirements respectively, namely, “the task is to create a text”, “the genre is prose”, “the topic is about wine”, “the word count is less than 100”, and “no ‘wine’ appears in the whole text”. The reference instruction can instruct the large model to generate response data that satisfies the plurality of first requirements corresponding to the plurality of first requirement categories.

As can be seen from the above example, the “requirement categories” may be understood as conditions that needs to be met in the process of generating response data using the large model, such as the genre of the generated content, the topic of the generated content, etc., The “requirements” corresponding to the “requirement categories” are used to describe specific conditions that need to be met in generating response data for the requirement categories, for example, for the requirement category of “genre of the generated content”, the large model is required to generate prose, or for the requirement category of “topic of the generated content”, the large model is required to generate content about wine.

In some embodiments, in step S202, a structured disassembly result of the reference instruction may be obtained to obtain the plurality of reference slots corresponding to the plurality of first requirement categories and the plurality of reference slot values corresponding to the plurality of first requirements. In an example embodiment, the above example reference instruction may be structurally disassembled to obtain five reference slots corresponding to the above five first requirement categories: “task”, “genre”, “topic”, “word count”, and “content requirements”, and to obtain five reference slot values corresponding to the above five first requirements: “text creation”, “prose”, “wine”, “<100 words” and “no ‘wine’ in the text”.

It is noted that the first requirement categories and the first requirements may be understood as abstract concepts of conditions that need to be met for the large model to generate the response data, and the reference slots and the reference slot values may be the specific, determined structured representations obtained by disassembling the abstract concepts. In some embodiments, the plurality of reference slots may be selected from a plurality of predetermined slots, and the plurality of candidate slot values may be selected from a plurality of predetermined slot values.

In some embodiments, the structured disassembly result of the reference instruction may, for example, be obtained by processing the reference instruction using a natural language instruction disassembly model. The natural language instruction disassembly model may be a classification model to enable selection of the plurality of reference slots corresponding to the reference instruction among the plurality of predetermined slots, and to enable selection of the plurality of reference slot values corresponding to the reference instruction among the plurality of predetermined slot values. The natural language instruction disassembly model may also be a generative model (which may be a different model from the larger model mentioned above) and directly obtains the plurality of reference slots and the plurality of reference slot values corresponding to the reference instruction in the way of content generation.

So far, through the above steps, the structured disassembly result of the reference instruction may be obtained, then statistical analysis may be performed on the reference instruction based on the structured disassembly result, and it can be determined that the sample instructions corresponding to which sample slots and which sample slot values need to be generated based on the corresponding result of the statistical analysis. In some embodiments, the sample instruction generation may also be directly performed based on the structured disassembly result of the reference instruction.

According to some embodiments, the predetermined rule may instruct to directly determine the plurality of reference slots as the plurality of sample slots and to directly determine the plurality of reference slot values as the plurality of sample slot values. As a result, rewriting of the reference instruction may be implemented. In addition, by structurally disassembling the reference instruction and then rewriting the instruction based on the structured disassembly result, it is ensured that each requirement category and each requirement of the reference instruction are embodied in the newly generated sample instruction, and it is guaranteed that the generated sample instruction is accurate.

In some embodiments, the plurality of sample slots and the plurality of sample slot values may be input into a natural language instruction generation model to obtain the sample instruction. The natural language instruction generation model may be another large model that is different from the large model mentioned above (e.g., may also be a deep learning-based language large model). The model is capable of combining the plurality of sample slot values corresponding to the plurality of sample slots to generate the natural language-based sample instruction. By using the natural language instruction disassembly model to obtain the disassembly result of the reference instruction and using the natural language instruction generation model to generate the sample instruction, a fully automated sample instruction generation process is implemented, during which no manual labor is required, thereby reducing the generation cost of the sample instruction, and increasing the generation speed.

According to some embodiments, in step S204, generating the natural language-based sample instruction based on the plurality of sample slots and the plurality of sample slot values includes: generating a plurality of sample instructions with different expressions but the same meaning using the natural language instruction generation model based on the plurality of sample slots and the plurality of sample slot values. As a result, a large number of sample instructions with different expressions but the same meaning can be automatically generated in the way described above, thereby facilitating and accelerating the large model to learn the corresponding slots and slot values. In addition, since these sample instructions have the same meaning, these sample instructions may correspond to the same ground truth response data, such that a large amount of sample data (including the sample instructions and the corresponding ground truth response data) can be generated quickly.

In an example embodiment, based on the five sample slots of “task,” “genre,” “topic,” “word count,” and “content requirements,” and the five sample slot values of “text creation”, “prose”, “wine”, “<100 words” and “‘no wine’ in the text”, a sample instruction of “write an essay, with the topic of wine, without the word “wine” in the text, and with the word count less than 100 words” is generated. In the example embodiments, since the sample slots are the same as the reference slots and the sample slot values are the same as the reference slot values, the plurality of second requirements corresponding to the sample instruction are the same as the plurality of first requirements corresponding to the reference instruction.

Turning back to step S203, according to some embodiments, the predetermined rule may instruct to randomly determine the plurality of sample slots among the plurality of reference slots, and to randomly determine the plurality of sample slot values among the plurality of reference slot values. As a result, a large number of sample instructions with different meanings may be automatically and quickly generated by the way of random determination, and the sample instructions with slot combinations or slot value combinations which have not appeared in training data or the online log data can be generated, thereby improving the generalization performance of the large model.

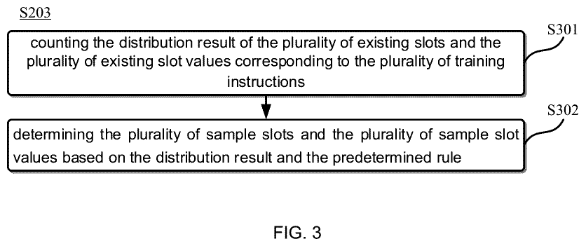

According to some embodiments, the reference instructions may include a plurality of training instructions obtained from a training set. As shown in FIG. 3, in step S203, determining the plurality of sample slots and the plurality of sample slot values corresponding to the plurality of sample slots based on the plurality of reference slots, the plurality of reference slot values, and the predetermined rule may include: step S301, counting the distribution result of the plurality of existing slots and the plurality of existing slot values corresponding to the plurality of training instructions, where the plurality of existing slots includes the plurality of reference slots corresponding to each of the plurality of training instructions, and the plurality of existing slot values includes the plurality of reference slot values corresponding to each of the plurality of training instructions; and step S302, determining the plurality of sample slots and the plurality of sample slot values based on the distribution result and the predetermined rule.

As a result, by structurally disassembling the training instructions in the training set, counting the distribution of the plurality of existing slots and the plurality of existing slot values corresponding to the plurality of training instructions, and determining the sample instructions need to be generated that correspond to which sample slots and which sample slot values, the construction and supplementation of the sample instruction data can be performed in a more targeted and systematic way.

In some embodiments, a structured instruction system set may be constructed after disassembling the plurality of training instructions, and the structured instruction system set includes all the slots (i.e., the plurality of existing slots) and all the slot values (i.e., the plurality of existing slot values) related to the plurality of training instructions. The process of randomly determining the sample slots/the sample slot values, which is described in the foregoing embodiments, may be performing randomly sampling in the instruction system set to form new sample instructions. After obtaining the instruction system set, the distribution result of the plurality of existing slots/existing slot values may be counted, such as the number of distributions of each of the existing slots/existing slot values. It would be understood that the distribution result may also include other content, such as the number of co-occurrences to be described below, which is not limited herein.

In some embodiments, the sample instructions included in the training set are often biased (e.g., a small number of specific slots/slot values or combinations thereof have a large number of distributions, while other slots/slot values or combinations thereof have a small number of distributions), and using such training set to train the large model may affect the quality of the response data it generates.

According to some embodiments, the predetermined rule may instruct to determine the plurality of sample slots based on at least a part of the existing slots with the least number of distributions among the plurality of existing slots, and/or the predetermined rule may instruct to determine the plurality of sample slot values based on at least a part of the existing slot values with the least number of distributions among the plurality of existing slot values. As a result, by analyzing which slots or slot values in the training instructions have more severe deficiencies based on the distribution results, the slots or slot values with severe deficiencies are determined as the sample slots or the sample slot values, the construction and supplementation of the sample instruction data are performed in a targeted manner, and then the corresponding training data which targets the deficiencies in the large model can be directed constructed, the bias in the training set can be overcome, and the quality of the response data generated by the large model can be improved.

In some embodiments, the predetermined rule may instruct to determine a part of the sample slots/sample slot values among the plurality of sample slots in the way described above, and determine another part of the sample slots/sample slot values in other ways (e.g., according to co-occurrence relationships, or random sampling); the predetermined rule may also instruct to determine all of the sample slots/sample slot values in the way described above.

In some embodiments, a predetermined number of existing slots/existing slot values with the least number of distributions among the plurality of existing slots/existing slot values may be determined as the sample slots/sample slot values, or the existing slots/existing slot values with the number of distributions less than a predetermined number among the plurality of existing slots/existing slot values may be determined as the sample slots/sample slot values, or the existing slots/existing slot values with severe training data deficiencies may be determined as the sample slots/sample slot values, which is not limited herein.

In some embodiments, in step S301, co-occurrences of the plurality of reference slot values/reference slots included in each of the plurality of training instructions may be counted to obtain the distribution results (e.g., the number of co-occurrences) of the plurality of existing slot value combinations/existing slot combinations. In an example embodiment, the existing slot combination composed of the slots of “genre” and “number of words” has a high number of co-occurrences, and the existing slots combination composed of the slots of “argumentative essay” and “>800 words” has a high number of co-occurrences.

Generally, the fewer slots/slot values included in the existing slot combination/existing slot value combination, the higher the number of co-occurrences; whereas fewer sample data has higher number of slots/slot values, which leads to the poor quality of the response data generated by the large model when processing users' complex instructions with more requirement categories or more requirements.

According to some embodiments, the predetermined rule may instruct to determine the plurality of sample slots based on the plurality of existing slot combinations with the highest number of co-occurrences, the number of the plurality of sample slots is more than the number of the existing slots included in any of the plurality of existing slot combinations, and/or the predetermined rule may instruct to determine the plurality of sample slot values based on the plurality of existing slot value combinations with the highest number of co-occurrences, the number of the plurality of sample slot values is more than the number of the existing slot values included in any of the plurality of existing slot value combinations.

Thereby, by counting the number of co-occurrences of the existing slot combinations/existing slot value combinations and determining the plurality of sample slots/sample slot values based on the plurality of existing slot combinations/existing slot value combinations with the highest number of co-occurrences, it is possible to reasonably construct richer and more complex sample instructions and effectively improve the ability of the large model to follow complex instructions.

In an example embodiment, the first existing slot combination composed of two slots of “genre” and “word count” has higher number of co-occurrences, and the second existing slot combination composed of two slots of “task” and “genre” slots also has higher number of co-occurrences, but the third existing slot combination composed of three slots of “task”, “genre” and “word count” has lower number of co-occurrences. By the way described above, a plurality of sample slots may be determined based on the first existing slot combination and the second existing slot combination, for example, by combining the first existing slot combination and the second existing slot combination to determine the three slots of “task”, “genre”, and “word count” as the sample slots. It may be understood that the plurality of sample slots/sample slot values may be determined in other ways based on the plurality of existing slot combinations/existing slot value combinations with the highest number of co-occurrences, which is not limited herein.

In some embodiments, the predetermined rule may instruct to determine some part of the sample slots/sample slot values among the plurality of sample slots by the way described above, and to determine another part of the sample slots/sample slot values by other ways (e.g., based on co-occurrence relationship, or random sampling); the predetermined rule may also instruct to determine all of the sample slots/sample slot values by the way described above.

In some embodiments, a predetermined number of existing slots/existing slot values with the least number of distributions among the plurality of existing slots/existing slot values may be determined as the sample slots/sample slot values, or the existing slots/existing slot values with the number of distributions less than a predetermined number among the plurality of existing slots/existing slot values may be determined as the sample slots/existing slot values, or the existing slots/existing slot values with severe training data deficiency may be determined as the sample slot/existing slot value in other ways, which is not limited herein.

According to some embodiments, the reference instructions may include target instructions obtained from online user logs. The plurality of reference slots corresponding to a target instruction may include target slots, and the plurality of reference slot values corresponding to a target instruction may include target slot values. The predetermined rule may instruct to set the target slot as the sample slot in response to determining that the plurality of existing slots do not include the target slot and/or the number of distributions of the target slot is less than a first predetermined value or less than the number of distributions of at least a part of the other existing slots, or the predetermined rule may instruct to set the target slot value as the sample slot value in response to determining that the plurality of existing slot values do not include the target slot value and/or the number of distributions of the target slot value is less than a second predetermined value or less than the number of distributions of at least a part of the other existing slot values.

As a result, by dissembling the target instructions obtained from the online user logs and determining the sample slots/sample slot values based on the number of occurrences of the target slots/target slot values included therein in the training instruction, the sample instruction data can be constructed and supplemented in a more targeted way, so that corresponding training data can be directionally constructed for the defects of the large model. In addition, through the continuous mining of online logs, the defects of the large model are continuously found, the supplementation capability of the corresponding instruction data is constructed, which will finally promote the large model to obtain a stronger instruction compliance capability.

In some embodiments, each of the plurality of reference slots/reference slot values corresponding to the target instruction may be taken as the target slots/target slot values and determined using the predetermined rule described above. It may be understood that the person skilled in the art may determine the foregoing first predetermined value, the second predetermined value, and the ranges of at least a portion of the other existing slots according to the needs, which is not limited herein.

In some embodiments, the predetermined rule may instruct to determine a part of the sample slots/sample slot values among the plurality of sample slots in the way described above, and to determine the other part of the sample slots/sample slot values in other ways (e.g., based on co-occurrence relationship, or random sampling); the predetermined rule may also instruct to determine all of the sample slots/sample slot values in the way described above.

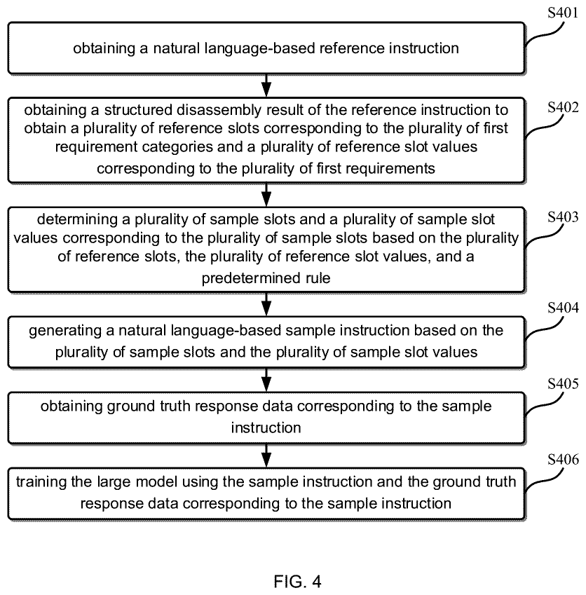

According to some embodiments, the large model may be a large language model. As shown in FIG. 4, the method of generating instruction data for the large model further includes: step S405, obtaining ground truth response data corresponding to the sample instruction; and step S406, training the large model using the sample instruction and the ground truth response data corresponding to the sample instruction. It would be understood that the operations of steps S401-S404 in FIG. 4 are similar to the operations of steps S201-S204 in FIG. 2, and will not be repeated herein.

As a result, by obtaining the ground truth response data corresponding to the sample instruction and training the large model using the ground truth response data and the sample instruction, instruction training data which is more complex, diverse, targeted and directed can be provided to the large model, and the instruction compliance capability of the large model can be effectively enhanced.

In some embodiments, in step S405, the ground truth response data may be obtained by manual labeling, or the ground truth response data may be obtained using model generation, or the ground truth response data may be obtained by other ways, which are not limited herein.

In some embodiments, in step S406, the sample instruction may be input into the large model to obtain prediction response data output by the large model, and then a loss value may be calculated based on the ground truth response data and the prediction response data, and the parameters of the large model are adjusted based on the loss value to train the large model. It would be understood that the large model may be trained using the sample instruction and the corresponding ground truth response data in other ways, which are not limited herein.

According to some embodiments, in step S406, training the large model using the sample instruction and the ground truth response data corresponding to the sample instruction may include: adding the sample instruction and the ground truth response data corresponding to the sample instruction to the training set to obtain a target training set; and training the large model using the target training set. As a result, by adding the sample instruction which is constructed based on the distribution result and the corresponding ground truth response data to the training set and using the training set to train the large model, it is possible to obtain a large model with more balanced and comprehensive capabilities.

In some embodiments, the instruction system set may be updated based on the updated target training set, and then the distribution result of the updated instruction system set is counted to generate new sample instructions and sample data to continuously improve the instruction compliance capability of the large model.

As described above, in some embodiments, for the plurality of sample slots and the plurality of sample slot values, a plurality of sample instructions with different expressions but the same meaning may be generated using a natural language instruction generation model. For these sample instructions, only one ground truth response data may be obtained, and each sample instruction and the ground truth response data may be combined and added to the training set, respectively.

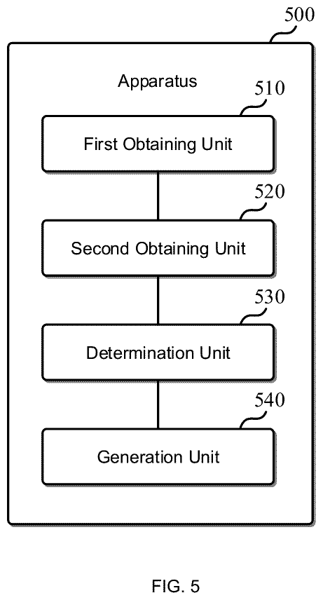

According to another aspect of the present disclosure, there is provided a device of generating instruction data for a large model. As shown in FIG. 5, the apparatus 500 includes: a first obtaining unit 510 configured to obtain a natural language-based reference instruction which can instruct the large model to generate response data that can satisfy a plurality of first requirements corresponding to a plurality of first requirement categories; a second obtaining unit 520 configured to obtain a structured disassembly result of the reference instructions to obtain a plurality of reference slots corresponding to the plurality of first requirement categories and a plurality of reference slot values corresponding to the plurality of first requirements; a determination unit 530 configured to determine a plurality of sample slots and a plurality of sample slot values corresponding to the plurality of sample slots based on the plurality of reference slots, the plurality of reference slot values, and a predetermined rule; and a generation unit 540 configured to generate a natural language-based sample instruction based on the plurality of sample slots and the plurality of sample slot values, and the sample instruction can instruct the large model to generate response data that satisfies a plurality of second requirements corresponding to the plurality of sample slot values.

It would be understood that the operations of the units 510-540 in the apparatus 500 are similar to the operations of the steps S201-S204 in FIG. 2 and will not be repeated here.

According to some embodiments, the predetermined rule may instruct to directly determine the plurality of reference slots as the plurality of sample slots and to directly determine the plurality of reference slot values as the plurality of sample slot values.

According to some embodiments, the predetermined rule may instruct to randomly determine the plurality of sample slots among the plurality of reference slots and to randomly determine the plurality of sample slot values among the plurality of reference slot values.

According to some embodiments, the reference instructions may include a plurality of training instructions obtained from the training set. The determination unit may include: a counting subunit configured to count the distribution result of the plurality of existing slots and the plurality of existing slot values corresponding to the plurality of training instructions, the plurality of existing slots include the plurality of reference slots corresponding to each of the plurality of training instructions, and the plurality of existing slot values include the plurality of reference slot values corresponding to each of the plurality of training instructions; and a determination subunit configured to determine the plurality of sample slots and the plurality of sample slot values based on the distribution result and the predetermined rule.

According to some embodiments, the predetermined rule may instruct to determine the plurality of sample slots based on at least a part of the existing slots with the least number of distributions among the plurality of existing slots, and/or the predetermined rule may instruct to determine the plurality of sample slot values based on at least part of the existing slot values with the least number of distributions among the plurality of existing slot values.

According to some embodiments, the predetermined rule may instruct to determine the plurality of sample slots based on the plurality of existing slot combinations with the highest number of co-occurrences, the number of the plurality of sample slots is more than the number of the existing slots included in any of the plurality of existing slot combinations, and/or the predetermined rule may instruct to determine the plurality of sample slot values based on the plurality of existing slot value combinations with the highest number of co-occurrences, the number of the plurality of sample slot values is more than the number of the existing slot values included in any of the plurality of existing slot value combinations.

According to some embodiments, the reference instructions may include target instructions obtained from online user logs. The plurality of reference slots corresponding to the target instruction include target slots, and the plurality of reference slot values corresponding to the target instruction include target slot values. The predetermined rule may instruct to set the target slot as the sample slot in response to determining that the plurality of existing slots do not include the target slot and/or the number of distributions of the target slot is less than a first predetermined value or less than the number of distributions of at least a part of the other existing slots, or the predetermined rule may instruct to set the target slot value as the sample slot value in response to determining that the plurality of existing slot values do not include the target slot value and/or the number of distributions of the target slot value is less than a second predetermined value or less than the number of distributions of at least a part of the other existing slot values.

According to some embodiments, the large model may be a deep learning-based large language model. The device 900 may further include (not shown in the figure): a third obtaining unit configured to obtain ground truth response data corresponding to the sample instruction; and a training unit configured to train the large model using the sample instruction and the ground truth response data corresponding to the sample instruction.

According to some embodiments, the training unit may include: an update subunit configured to add the sample instruction and the ground truth response data corresponding to the sample instruction to the training set to obtain a target training set; and a training subunit configured to train the large model using the target training set.

According to some embodiments, the generation unit may include: a generation subunit configured to generate a plurality of sample instructions with different expressions but the same meaning using a natural language instruction generation mode based on the plurality of sample slots and the plurality of sample slot values.

In the technical solution of the present disclosure, the collection, storage, use, processing, transmission, provision and disclosure of personal information of users involved are in compliance with relevant laws and regulations and do not violate public order and morals.

According to embodiments of the present disclosure, there is provided an electronical device, a readable storage medium and a computer program product.

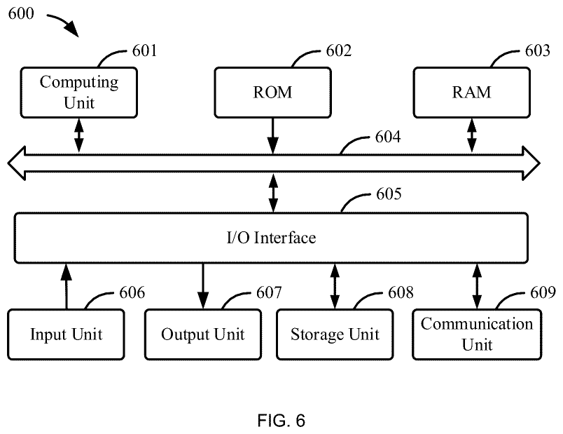

Referring to FIG. 6, a structural block diagram of an electronic device 600 that may be a server or client of the present disclosure is now described, which is an example of a hardware device that may be applied to aspects of the present disclosure. Electronic devices are intended to represent various forms of digital electronic computer devices, such as laptop computers, desktop computers, workstations, personal digital assistants, servers, blade servers, mainframe computers, and other suitable computers. The electronic devices may also represent various forms of mobile devices, such as personal digital processing, cellular telephones, smart phones, wearable devices, and other similar computing devices. The components shown herein, their connections and relationships, and their functions are merely as examples, and are not intended to limit the implementations of the disclosure described and/or claimed herein.

As shown in FIG. 6, the electronic device 600 includes a computing unit 601, which may perform various appropriate actions and processing according to a computer program stored in a read-only memory (ROM) 602 or a computer program loaded into a random access memory (RAM) 603 from a storage unit 608. In the RAM 603, various programs and data required by the operation of the electronic device 600 may also be stored. The computing unit 601, the ROM 602, and the RAM 603 are connected to each other through a bus 604. Input/output (I/O) interface 605 is also connected to the bus 604.

A plurality of components in the electronic device 600 are connected to a I/O interface 605, including: an input unit 606, an output unit 607, a storage unit 608, and a communication unit 609. The input unit 606 may be any type of device capable of inputting information to the electronic device 600, the input unit 606 may receive input digital or character information and generate a key signal input related to user setting and/or function control of the electronic device, and may include, but is not limited to, a mouse, a keyboard, a touch screen, a track pad, a trackball, a joystick, a microphone, and/or a remote control. The output unit 607 may be any type of device capable of presenting information, and may include, but are not limited to, a display, a speaker, a video/audio output terminal, a vibrator, and/or a printer. The storage unit 608 may include, but is not limited to, a magnetic disk and an optical disk. The communication unit 609 allows the electronic device 600 to exchange information/data with other devices over a computer network, such as the Internet, and/or various telecommunication networks, and may include, but is not limited to, a modem, a network card, an infrared communication device, a wireless communication transceiver and/or a chipset, such as a Bluetooth device, a 802.11 device, a WiFi device, a WiMAX device, a cellular communication device, and/or the like.

The computing unit 601 may be a variety of general and/or special purpose processing components with processing and computing capabilities. Some examples of the computing unit 601 include, but are not limited to, a central processing unit (CPU), a graphics processing unit (GPU), various dedicated artificial intelligence (AI) computing chips, various computing units running machine learning model algorithms, a digital signal processor (DSP), and any suitable processor, controller, microcontroller, etc. The computing unit 601 performs the various methods and processes described above, such as the method of generating instruction data for a large model. For example, in some embodiments, the method of generating instruction data for a large model may be implemented as a computer software program tangibly contained in a machine-readable medium, such as the storage unit 608. In some embodiments, part or all of the computer program may be loaded and/or installed onto the electronic device 600 via the ROM 602 and/or the communication unit 609. When the computer program is loaded into the RAM 603 and executed by the computing unit 601, one or more steps of the method of generating instruction data for a large model described above may be performed. Alternatively, in other embodiments, the computing unit 601 may be configured to perform the method of generating instruction data for a large model by any other suitable means (e.g., with the aid of firmware).

Various embodiments of the systems and techniques described above herein may be implemented in a digital electronic circuit system, an integrated circuit system, a field programmable gate array (FPGA), an application specific integrated circuit (ASIC), a dedicated standard product (ASSP), a system of system on a chip system (SoC), a complex programmable logic device (CPLD), computer hardware, firmware, software, and/or combinations thereof. These various embodiments may include: implementation in one or more computer programs that may be executed and/or interpreted on a programmable system including at least one programmable processor, where the programmable processor may be a dedicated or universal programmable processor that may receive data and instructions from a storage system, at least one input device, and at least one output device, and transmit data and instructions to the storage system, the at least one input device, and the at least one output device.

The program code for implementing the method of the present disclosure may be written in any combination of one or more programming languages. These program code may be provided to a processor or controller of a general-purpose computer, a special purpose computer, or other programmable data processing device such that the program code, when executed by the processor or controller, causes the functions/operations specified in the flowchart and/or block diagram to be implemented. The program code may be executed entirely on the machine, partly on the machine, partly on the machine as a stand-alone software package and partly on the remote machine or entirely on the remote machine or server.

In the context of the present disclosure, a machine-readable medium may be a tangible medium, which may contain or store a program for use by or in connection with an instruction execution system, device, or device. The machine-readable medium may be a machine-readable signal medium or a machine-readable storage medium. The machine-readable medium may include, but is not limited to, electronic, magnetic, optical, electromagnetic, infrared, or semiconductor systems, apparatus, or devices, or any suitable combination of the foregoing. More specific examples of a machine-readable storage media may include an electrical connection based on one or more wires, a portable computer disk, a hard disk, a random access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination of the foregoing.

To provide interaction with a user, the systems and techniques described herein may be implemented on a computer having: a display device (e.g., a CRT (cathode ray tube) or an LCD (liquid crystal display) monitor) for displaying information to a user; and a keyboard and pointing device (e.g., a mouse or trackball) by which a user may provide input to the computer. Other types of devices may also be used to provide interaction with a user; for example, the feedback provided to the user may be any form of perception feedback (e.g., visual feedback, auditory feedback, or tactile feedback); and the input from the user may be received in any form (including acoustic input, voice input, or haptic input).

The systems and techniques described herein may be implemented in a computing system including a back-end component (e.g., as a data server), or a computing system including a middleware component (e.g., an application server), or a computing system including a front-end component (e.g., a user computer with a graphical user interface or a web browser, the user may interact with implementations of the systems and techniques described herein through the graphical user interface or the web browser), or in a computing system including any combination of such back-end components, middleware components, or front-end components. The components of the system may be interconnected by digital data communication (e.g., a communications network) in any form or medium. Examples of communication networks include a local area network (LAN), a wide area network (WAN), the Internet, and a blockchain network.

The computer system may include a client and a server. Clients and servers are generally remote from each other and typically interact through a communication network. The relationship between clients and servers is generated by computer programs running on respective computers and having a client-server relationship to each other. The server may be a cloud server, or may be a server of a distributed system, or a server incorporating a blockchain.

It should be understood that the various forms of processes shown above may be used, and the steps may be reordered, added, or deleted. For example, the steps described in the present disclosure may be performed in parallel or sequentially or in a different order, as long as the results expected by the technical solutions disclosed in the present disclosure can be achieved, and no limitation is made herein.

Although embodiments or examples of the present disclosure have been described with reference to the accompanying drawings, it should be understood that the foregoing methods, systems, and devices are merely embodiments or examples, and the scope of the present disclosure is not limited by these embodiments or examples, but is only defined by the authorized claims and their equivalents. Various elements in the embodiments or examples may be omitted or may be replaced by equivalent elements thereof. Further, the steps may be performed by a different order than described in this disclosure. Further, various elements in the embodiments or examples may be combined in various ways. Importantly, with the evolution of technologies, many elements described herein may be replaced by equivalent elements appearing after the present disclosure.

1. A computer-implemented method of generating instruction data for a large model, comprising:
obtaining a natural language-based reference instruction, wherein the reference instruction can instruct the large model to generate response data that satisfies a plurality of first requirements corresponding to a plurality of first requirement categories;
obtaining a structured disassembly result of the reference instruction to obtain a plurality of reference slots corresponding to the plurality of first requirement categories and a plurality of reference slot values corresponding to the plurality of first requirements;
determining a plurality of sample slots and a plurality of sample slot values corresponding to the plurality of sample slots based on the plurality of reference slots, the plurality of reference slot values, and a predetermined rule; and
generating a natural language-based sample instruction based on the plurality of sample slots and the plurality of sample slot values, wherein the sample instruction can instruct the large model to generate response data that satisfies a plurality of second requirements corresponding to the plurality of sample slot values.

2. The method of claim 1, wherein the reference instructions include a plurality of training instructions obtained from a training set,
wherein determining the plurality of sample slots and the plurality of sample slot values corresponding to the plurality of sample slots comprises:
counting a distribution result of a plurality of existing slots and a plurality of existing slot values corresponding to the plurality of training instructions, wherein the plurality of existing slots comprises a plurality of reference slots corresponding to each training instruction of the plurality of training instructions, and the plurality of existing slot values comprises a plurality of reference slot values corresponding to each training instruction of the plurality of training instructions; and
determining the plurality of sample slots and the plurality of sample slot values based on the distribution result and the predetermined rule.

3. The method of claim 2, wherein the predetermined rule instructs to determine the plurality of sample slots based on at least a part of the existing slots with a least number of distributions among the plurality of existing slots, and/or
the predetermined rule instructs to determine the plurality of sample slot values based on at least a part of the existing slot values with a least number of distributions among the plurality of existing slot values.

4. The method of claim 2, wherein the predetermined rule instructs to determine the plurality of sample slots based on a plurality of existing slot combinations with a highest number of co-occurrences, wherein a number of the plurality of sample slots is more than a number of the existing slots included in any existing slot combination of the plurality of existing slot combinations, and/or
the predetermined rule instructs to determine the plurality of sample slot values based on a plurality of existing slot value combinations with a highest number of co-occurrences, wherein a number of the plurality of sample slot values is more than a number of the existing slot values included in any existing slot value combination of the plurality of existing slot value combinations.

5. The method of claim 2, wherein the reference instructions include target instructions obtained from online user logs, the plurality of reference slots corresponding to the target instruction include target slots, and the plurality of reference slot values corresponding to the target instruction include target slot values,
wherein the predetermined rule instructs to set the target slot as the sample slot in response to determining that the plurality of existing slots do not include the target slot or a number of distributions of the target slot is less than a first predetermined value or less than a number of distributions of at least a part of the other existing slots, and/or
the predetermined rule instructs to set the target slot value as the sample slot value in response to determining that the plurality of existing slot values do not include the target slot value, or a number of distributions of the target slot value is less than a second predetermined value or less than a number of distributions of at least a part of the other existing slot values.

6. The method of claim 1, wherein generating the natural language-based sample instruction comprises:
generating a plurality of sample instructions with different expressions but a same meaning using a natural language instruction generation model based on the plurality of sample slots and the plurality of sample slot values.

7. The method of claim 6, wherein the predetermined rule instructs to directly determine the plurality of reference slots as the plurality of sample slots, and to directly determine the plurality of reference slot values as the plurality of sample slot values.

8. The method of claim 1, wherein the predetermined rule instructs to randomly determine the plurality of sample slots among the plurality of reference slots, and to randomly determine the plurality of sample slot values among the plurality of reference slot values.

9. The method of claim 2, wherein the large model is a deep learning-based large language model, and the method further comprises:
obtaining ground truth response data corresponding to the sample instruction; and
training the large model using the sample instruction and the ground truth response data corresponding to the sample instruction.

10. The method of claim 9, wherein training the large model using the sample instruction and the ground truth response data corresponding to the sample instruction comprises:
adding the sample instruction and the ground truth response data corresponding to the sample instruction to the training set to obtain a target training set; and
training the large model using the target training set.

11. An electronic device, comprising:
one or more processors;
a memory storing one or more programs configured to be executed by the one or more processors, the one or more programs including instructions for:
obtaining a natural language-based reference instruction, wherein the reference instruction can instruct the large model to generate response data that satisfies a plurality of first requirements corresponding to a plurality of first requirement categories;
obtaining a structured disassembly result of the reference instruction to obtain a plurality of reference slots corresponding to the plurality of first requirement categories and a plurality of reference slot values corresponding to the plurality of first requirements;
determining a plurality of sample slots and a plurality of sample slot values corresponding to the plurality of sample slots based on the plurality of reference slots, the plurality of reference slot values, and a predetermined rule; and
generating a natural language-based sample instruction based on the plurality of sample slots and the plurality of sample slot values, wherein the sample instruction can instruct the large model to generate response data that satisfies a plurality of second requirements corresponding to the plurality of sample slot values.

12. The electronic device of claim 11, wherein the reference instructions include a plurality of training instructions obtained from a training set,
wherein determining the plurality of sample slots and the plurality of sample slot values corresponding to the plurality of sample slots comprises:
counting a distribution result of a plurality of existing slots and a plurality of existing slot values corresponding to the plurality of training instructions, wherein the plurality of existing slots comprises a plurality of reference slots corresponding to each training instruction of the plurality of training instructions, and the plurality of existing slot values comprises a plurality of reference slot values corresponding to each training instruction of the plurality of training instructions; and
determining the plurality of sample slots and the plurality of sample slot values based on the distribution result and the predetermined rule.

13. The electronic device of claim 12, wherein the predetermined rule instructs to determine the plurality of sample slots based on at least a part of the existing slots with a least number of distributions among the plurality of existing slots, and/or
the predetermined rule instructs to determine the plurality of sample slot values based on at least a part of the existing slot values with a least number of distributions among the plurality of existing slot values.

14. The electronic device of claim 12, wherein the predetermined rule instructs to determine the plurality of sample slots based on a plurality of existing slot combinations with a highest number of co-occurrences, wherein a number of the plurality of sample slots is more than a number of the existing slots included in any existing slot combination of the plurality of existing slot combinations, and/or
the predetermined rule instructs to determine the plurality of sample slot values based on a plurality of existing slot value combinations with a highest number of co-occurrences, wherein a number of the plurality of sample slot values is more than a number of the existing slot values included in any existing slot value combination of the plurality of existing slot value combinations.

15. The electronic device of claim 12, wherein the reference instructions include target instructions obtained from online user logs, the plurality of reference slots corresponding to the target instruction include target slots, and the plurality of reference slot values corresponding to the target instruction include target slot values,
wherein the predetermined rule instructs to set the target slot as the sample slot in response to determining that the plurality of existing slots do not include the target slot or a number of distributions of the target slot is less than a first predetermined value or less than a number of distributions of at least a part of the other existing slots, and/or
the predetermined rule instructs to set the target slot value as the sample slot value in response to determining that the plurality of existing slot values do not include the target slot value, or a number of distributions of the target slot value is less than a second predetermined value or less than a number of distributions of at least a part of the other existing slot values.

16. The electronic device of claim 11, wherein generating the natural language-based sample instruction comprises:
generating a plurality of sample instructions with different expressions but a same meaning using a natural language instruction generation model based on the plurality of sample slots and the plurality of sample slot values.

17. The electronic device of claim 16, wherein the predetermined rule instructs to directly determine the plurality of reference slots as the plurality of sample slots, and to directly determine the plurality of reference slot values as the plurality of sample slot values.

18. The electronic device of claim 12, wherein the large model is a deep learning-based large language model, and the one or more programs further including instructions for:
obtaining ground truth response data corresponding to the sample instruction; and
training the large model using the sample instruction and the ground truth response data corresponding to the sample instruction.

19. The electronic device of claim 18, wherein training the large model using the sample instruction and the ground truth response data corresponding to the sample instruction comprises:
adding the sample instruction and the ground truth response data corresponding to the sample instruction to the training set to obtain a target training set; and
training the large model using the target training set.

20. A non-transient computer-readable storage medium storing one or more programs, the one or more programs comprising instructions, which when executed by one or more processors of an electronic device, cause the electronic device to:
obtain a natural language-based reference instruction, wherein the reference instruction can instruct the large model to generate response data that satisfies a plurality of first requirements corresponding to a plurality of first requirement categories;
obtain a structured disassembly result of the reference instruction to obtain a plurality of reference slots corresponding to the plurality of first requirement categories and a plurality of reference slot values corresponding to the plurality of first requirements;
determine a plurality of sample slots and a plurality of sample slot values corresponding to the plurality of sample slots based on the plurality of reference slots, the plurality of reference slot values, and a predetermined rule; and
generate a natural language-based sample instruction based on the plurality of sample slots and the plurality of sample slot values, wherein the sample instruction can instruct the large model to generate response data that satisfies a plurality of second requirements corresponding to the plurality of sample slot values.
